(19) United States
(12) Patent Application Publication
(10) Pub. No.: US 2017/0277849 A1
(43) Pub. Date: Sep. 28, 2017

(54) SYSTEMS AND METHODS FOR DISPLAYING WAVEFORMS BASED ON PHYSIOLOGICAL DATA

(71) Applicant: General Electric Company, Schenectady, NY (US)

(72) Inventors: Hardikkumar Kiritkumar Soni, Bangalore (IN); Aditi Swaroop, Bangalore (IN)

(21) Appl. No.: 15/452,250

(22) Filed: Mar. 7, 2017

(30) Foreign Application Priority Data
Mar. 22, 2016 (IN) 201641009927

(51) Int. Cl. G06F 19/00

(52) U.S. Cl. CPC G06F 19/3406; G06F 19/324; G06F 19/3487; G06F 3/04845

(57) ABSTRACT

System that is configured to display a health-monitoring graph on a screen of the user display. The health-monitoring graph includes a waveform that represents the physiological data that is plotted with respect to horizontal and vertical axes. The processor is also configured to monitor a perceived graph characteristic of the health-monitoring graph. The perceived graph characteristic is related to at least one of the waveform as displayed on the screen or an area of the health-monitoring graph as displayed on the screen. The system is also configured to determine the perceived graph characteristic is improper relative to a standard graph characteristic for displaying the physiological data. In response to determining that the perceived graph characteristic is improper, the system is configured to at least one of notify the user that the perceived graph characteristic is improper or adjust the health-monitoring graph on the screen.

### CROSS-REFERENCE TO RELATED APPLICATIONS

This application claims priority to IN patent application number 201641009927, filed on Mar. 22, 2016, the entirety of which is incorporated herein by reference.

### BACKGROUND

The subject matter herein relates generally to systems and methods for displaying data, and more particularly, to systems and methods for displaying waveforms.

When a patient is admitted into a healthcare facility, the patient is often connected to a monitoring system that detects and records one or more physiological parameters (e.g., heartbeat, electrocardiography (ECG) data, etc.). Conventional systems often display the physiological parameters to a healthcare provider as a waveform. For example, waveforms may be used to represent ECG data, blood pressure, pulse oximetry, electromyography data, cardiotocography data, electroencephalography data, and polygraphy data (i.e., lie detection). Traditional systems typically include a roll of strip paper having a pattern of visual indicators (e.g., gridlines), a writing system that makes traces along the strip of paper, and sensors that are connected to the writing system. The sensors may be, for example, attached to an individual at predetermined regions of the body. As the paper is rolled out at a predetermined speed, the writing system makes traces onto the paper that are indicative of the detected signals obtained through the sensors. The paper having traces thereon may be referred to as a strip chart. The visual indicators, the predetermined speed, and the traces may be configured so that the resulting waveform is in accordance with an established standard for the physiological parameter.

Conventional systems today include user displays that present an electronic chart documents to a user of the system. Electronic chart documents are configured to appear similar to the strip charts created by the traditional systems and may comprise waveform displays. For example, the electronic chart documents are configured to have waveforms with aspect ratios that match the aspect ratios of established standards. Medical providers (e.g., doctors, nurses, technicians, and the like) are typically trained to review waveform data using the established standards so that the medical providers are conditioned to identify certain patterns in the waveforms. Thus, it is desirable for the electronic chart documents to appear similar to the traditional strip charts. More recently, however, electronic chart documents are being displayed on smaller and more portable devices (e.g., portable computers, tablets, smartphones), which can create challenges for displaying the waveforms.

### BRIEF DESCRIPTION

In an embodiment, a system is provided that includes a plurality of sensors that are configured to detect physiological data from an individual. The system also includes a user display configured to present viewable information to a user of the system that is based on the physiological data. The system also includes a processor and a storage medium that is configured to store program instructions accessible by the processor, wherein, responsive to execution of the program instructions, the processor is configured to display a health-monitoring graph on a screen of the user display. The health-monitoring graph includes a waveform that represents the physiological data that is plotted with respect to horizontal and vertical axes. The processor is also configured to monitor a perceived graph characteristic of the health-monitoring graph. The perceived graph characteristic is related to at least one of the waveforms as displayed on the screen or an area of the health-monitoring graph as displayed on the screen. The processor is also configured to determine the perceived graph characteristic is improper relative to a standard graph characteristic for displaying the physiological data. In response to determining that the perceived graph characteristic is improper, the processor is configured to at least one of notify the user that the perceived graph characteristic is improper or adjust the health-monitoring graph on the screen so that that the perceived graph characteristic is proper relative to the standard graph characteristic.

In some aspects, the perceived graph characteristic is at least one of an aspect ratio, a channel width, a channel height, a vertical gain, or a sweep speed.

In some aspects, displaying the health-monitoring graph to the user includes displaying the health-monitoring graph to the user through an application program that is configured to retrieve data for the health-monitoring graph through a communication network. Optionally, the determining operation includes obtaining size information through the application program. The size information may be at least one of a zoom level of the application program, a viewport size of the application program, or a device pixel ratio. Also optionally, the determining operation may be performed by a sub-application invoked by the application program.

In some aspects, the monitoring operation includes identifying that a graph-changing event has occurred and, in response to identifying that a graph-changing event has occurred, determining the perceived graph characteristic.

In some aspects, notifying the user includes at least one of (a) providing audible information to the user through an audio system of the device or system; (b) displaying a non-textural alert to the user on the screen; (c) or displaying a textual alert to the user.

Optionally, the physiological data may be at least one of cardiotocographic data, electrocardiographic data, electroencephalographic data, electromyographic data, electronystagmographic, or polygraphic data.

In an embodiment, a method is provided that includes displaying a health-monitoring graph on a screen of a computing system. The health-monitoring graph includes a waveform that represents physiological data of an individual that is plotted with respect to horizontal and vertical axes. The method also includes monitoring a perceived graph characteristic of the health-monitoring graph. The perceived graph characteristic is related to at least one of the waveform as displayed on the screen or an area of the health-monitoring graph as displayed on the screen. The method also includes determining the perceived graph characteristic is improper relative to a standard graph characteristic for displaying the physiological data. In response to determining that the perceived graph characteristic is improper, the method includes at least one of notifying the user that the perceived graph characteristic is improper or adjusting the health-monitoring graph on the screen so that that the perceived graph characteristic is proper relative to the standard graph characteristic.

In an embodiment, a non-transitory computer-readable storage medium having computer executable code is provided. The computer executable code is configured to display a health-monitoring graph on a screen of a computing system. The health-monitoring graph includes a waveform that represents physiological data of an individual that is plotted with respect to horizontal and vertical axes. The computer executable code is also configured to monitor a perceived graph characteristic of the health-monitoring graph. The perceived graph characteristic is related to at least one of the waveform as displayed on the screen or an area of the health-monitoring graph as displayed on the screen. The computer executable code is also configured to determine the perceived graph characteristic is improper relative to a standard graph characteristic for displaying the physiological data. In response to determining that the perceived graph characteristic is improper, the computer executable code is configured to at least one of notify the user that the perceived graph characteristic is improper or adjust the health-monitoring graph on the screen so that that the perceived graph characteristic is proper relative to the standard graph characteristic.

### BRIEF DESCRIPTION OF THE DRAWINGS

FIG. 1 is a block diagram of an exemplary system in accordance with an embodiment.

FIG. 2 illustrates an exemplary health-monitoring graph that may be displayed by the system of FIG. 1.

FIG. 3 illustrates a user display having a viewable area in accordance with an embodiment.

FIG. 4 illustrates a user display having a viewable area in accordance with an embodiment in which a health-monitoring graph has an improper aspect ratio.

FIG. 5 illustrates a user display having a viewable area in accordance with an embodiment in which a health-monitoring graph has an improper aspect ratio.

FIG. 6 illustrates a user display having a viewable area in accordance with an embodiment in which a health-monitoring graph has an improper aspect ratio.

FIG. 7 illustrates a user display having a viewable area in accordance with an embodiment in which a health-monitoring graph has an improper aspect ratio.

FIG. 8 is a flowchart illustrating a method in accordance with an embodiment.

### DETAILED DESCRIPTION

Embodiments described herein include systems and methods that display waveforms. One or more embodiments may be configured to identify whether the waveforms have a suitable appearance. One or more embodiments may monitor a perceived graph characteristic that is displayed on a screen of a computing system to the user. The perceived graph characteristic may be used to determine that the graph is distorted or improperly proportioned and may be (a) any identifiable characteristic of a graph and/or (b) any identifiable characteristic of a waveform that is displayed on the graph. For example, the graph characteristics may be at least one of an aspect ratio, a channel width, a channel height, a vertical gain, or a sweep speed. In particular embodiments, the perceived graph characteristic is an aspect ratio of the waveform or a graph characteristic that determines and/or is directly related to the aspect ratio, such as the vertical sensitivity (e.g., vertical gain) or the horizontal sensitivity (e.g., sweep speed). Other graph characteristics may determine and/or be directly related to the aspect ratio, such as dimensions of the displayed graph or chart.

Yet in other embodiments the perceived graph characteristic(s) may not be directly related to the appearance of the waveform. For example, the perceived graph characteristic may be a pattern of visual cues or indicators that facilitate understanding the waveform. As another example, the perceived graph characteristics may include textual information (e.g., numbers and/or letters) that relate directly or indirectly to the waveform. For instance, embodiments may determine whether numbers or letters are displayed properly on the display. Numbers may be improperly displayed when the numbers do not have the correct size (e.g., height, width, or both), aspect ratio, correct font, or correct position on the screen relative to a predetermined standard. Likewise, letters may be improperly displayed when the numbers do not have the correct size (e.g., height, width, or both), aspect ratio, correct font, or correct position on the screen relative to a predetermined standard.

The waveforms typically form characteristic patterns that are identifiable by users of the system. For example, electrocardiography (ECG) waveforms may include PQRST wave patterns that provide useful information to a user for identifying a health status of an individual. The waveforms may be configured to have aspect ratios (or other waveform characteristics) that are effectively equal to standard aspect ratios (or other waveform characteristics) for a physiological parameter-of-interest. The waveforms may represent physiological data (e.g., measurements) obtained from individuals. In other embodiments, the waveforms may relate to seismic measurements or other measurements of an environment.

Although the various embodiments may be described in connection with ECG, the methods and systems described herein are not limited to ECG. For instance, embodiments described herein may also be used in connection with cardiotocography, polygraphy (i.e., lie detection), electroencephalography, electromyography, electronystagmography, or seismology, among others. Physiological information displayed by embodiments described herein may relate to, for example, a heart rate, body temperature, blood pressure, respiratory rate, electrical activity, intrauterine pressure, or other parameter that may be analyzed to provide meaningful information regarding a human or animal condition. Waveforms are typically plotted as a function of time, but it is contemplated that other waveforms may be plotted as a function of a non-temporal parameter.

When a health-monitoring graph (or a chart document that includes the health-monitoring graph) is presented in a user display, the health-monitoring graph (or chart document) may become distorted with respect to a standard size or shape. For example, devices often have different screen sizes and/or different device pixel ratios. Some devices, such as portable devices, are configured to change the display based on the orientation of the device. For example, a first orientation of the device may be a portrait orientation (or vertical orientation) and a second orientation of the device may be a landscape orientation (or horizontal orientation). In order to improve the viewing area for the different orientations, the device may re-orient the information displayed based on the orientation of the device. Moreover, different web browsers may have different manners of displaying images, videos, and the like. Different web browsers may also implement different methods for zooming into or away from images, videos, or text that are displayed within the browser. Some web browsers enable a user to customize the zooming options. Accordingly, various factors or circumstances may cause health-monitoring graphs to be distorted such that graph characteristics (e.g., waveforms, numbers, letters, etc.) of the health-monitoring graphs are not properly displayed relative to a predetermined standard.

Embodiments set forth herein may be configured to determine that a waveform is not displayed in accordance with a predetermined standard or that other graph characteristics are not displayed in accordance with a predetermined standard. In particular, embodiments may analyze features or characteristics of a chart on the user display and/or features or characteristics of the displayed waveform in the chart to determine that one or more graph characteristics are improper relative to corresponding standard graph characteristics. Embodiments may, for instance, analyze one or more perceived graph characteristics. If a perceived graph characteristic does not satisfy a predetermined condition, then the perceived characteristic may be determined to be improper relative to the standard graph characteristic. The graph characteristics may be any portion of the health-monitoring graph that provides or facilitates providing information to the user. The graph characteristics may be, for example, waveforms that represent physiological data, text that identifies certain information (e.g., patient information or labels for the waveforms), or numerical values that represent certain parameters. The graph characteristics may also be features or qualities of the above. For example, the graph characteristics may include a horizontal sensitivity, a vertical sensitivity, and/or an aspect ratio of the waveform. Each of the above and other examples provided herein may become distorted on a display during operation of the computing device.

In some embodiments, the graph characteristics may be defined by values and these values may be used to determine (a) whether the perceived graph characteristic is within an acceptable range of values for a characteristic-of-interest; (b) whether the perceived graph characteristic is above a threshold; or (c) (b) whether the perceived graph characteristic is below a threshold. For example, if the perceived graph characteristic is within the acceptable range of values, then it is determined that the perceived graph characteristic is proper relative to the standard graph characteristic. If the perceived graph characteristic is not within the acceptable range of values, then it is determined that the perceived graph characteristic is improper relative to the standard graph characteristic. A similar analysis may be performed if, instead of an acceptable range of values, the test is whether the value of the perceived graph characteristic is above or below a threshold. The acceptable range of values or the thresholds may be based on a standard graph characteristic.

For example when the characteristic-of-interest is the horizontal sensitivity (e.g., sweep speed), embodiments may analyze the perceived horizontal sensitivity relative to acceptable horizontal sensitivity values. Embodiments may determine whether the horizontal sensitivity is within a range of values. Alternatively or in addition to the above, embodiments may analyze the perceived vertical sensitivity relative to acceptable vertical sensitivity values. If the perceived vertical sensitivity is not within a range of acceptable values, then embodiments may determine that the vertical sensitivity is improper. Likewise, embodiments may analyze the aspect ratio relative to acceptable ratio values. If the aspect ratio is not within a range of acceptable values for the aspect ratio, then embodiments may determine that the aspect ratio is improper.

A range of acceptable values for a graph characteristic may be based on a number of factors. For example, the range of acceptable values may be based on a standard or predetermined value that is established by at least one of equipment manufacturers, clinicians, standards agencies, or a governmental authority and/or that is considered a standard in the field-of-interest. By way of example only, a range of values may be a predetermined standard value X±35% of the predetermined standard value (e.g., 0.65X to 1.35X). In particular embodiments, the range of values may be the predetermined standard value X±20% of the predetermined standard value X (e.g., 0.8X to 1.2X). In more particular embodiments, the range of values may be the predetermined standard value X±10% of the predetermined standard value X (e.g., 0.9X to 1.1X) or, more particularly, ±5% of the predetermined standard value X (e.g., 0.95X to 1.05X).

As used herein, a “standard aspect ratio” is a predetermined ratio of a vertical sensitivity to a horizontal sensitivity (or vice versa). The standard aspect ratio may be an aspect ratio that is established by equipment manufacturers, clinicians, standards agencies, or a governmental authority and/or that is considered a standard in the field-of-interest. The standard aspect ratio (or sensitivity) may also be determined by the user. For instance, the user may select a standard aspect ratio or sensitivity for any displayed waveforms to be compared to. As one particular example, a sensitivity that may function as a standard aspect range for ECG waveforms is 0.40±0.08 s/mV, in which the aspect ratio (e.g., 0.40) is the ratio of vertical gain to sweep speed. The sensitivity has an acceptable minimum aspect ratio of 0.32 and an acceptable maximum aspect ratio of 0.48.

In some embodiments, a number of perceived graph characteristics may be analyzed to determine if each of the perceived graph characteristics is proper. For example, some embodiments may: (a) determine that the horizontal sensitivity is sufficient; (b) determine that the vertical sensitivity is sufficient; and (c) determine that the aspect ratio is sufficient. If all three are sufficient, then the perceived graph characteristics are proper. If any of the graph characteristics are improper, embodiments may initiate corrective action and/or notify the user. Corrective action may adjust the health-monitoring graph as a whole (e.g., increase entire size as a unit) or may selectively correct sections or areas of the health-monitoring graph without substantially changing other sections or areas of the health-monitoring graph. Optionally, embodiments may determine whether at least a minimum amount of area is covered by the graph or chart.

At least one technical effect of some embodiments includes notifying a user that a waveform of physiological data is incorrectly displayed and allowing the user to correct the appearance of the waveform without changing the underlying data. Consequently, the user may more quickly and/or accurately diagnose a health status or condition of the individual. Fewer mistakes in diagnosing the health status may occur. Another technical effect for some embodiments may include informing the user to what extent the waveform is incorrectly displayed and/or how the display may be corrected so that the waveform is suitable. Another technical effect for some embodiments may include requesting the user's permission to correct the display of the waveform or automatically correcting the display of the waveform.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments that “comprise,” “have,” or “include” an element or a plurality of elements that have a particular property may also include additional such elements that do not have that particular property. Furthermore, when an element is described as being based on a factor or parameter, the term “based on” should not be interpreted as the factor or parameter being the sole factor or parameter, but may include the possibility that the element is also based on other factors or parameters.

The following detailed description of certain embodiments will be better understood when read in conjunction with the appended drawings. To the extent that the figures illustrate diagrams of the functional blocks of various embodiments, the functional blocks are not necessarily indicative of the division between hardware circuitry. For example, one or more of the functional blocks (e.g., modules, processors, or memories) may be implemented in a single piece of hardware (e.g., a general purpose signal processor or random access memory, hard disk, or the like). Similarly, programs may be stand alone programs, may be incorporated as subroutines in an operating system, may be functions in an installed software package, may be a software surface package that is run from a computer server remotely, and the like. It should be understood that the various embodiments are not limited to the arrangements and instrumentality shown in the drawings.

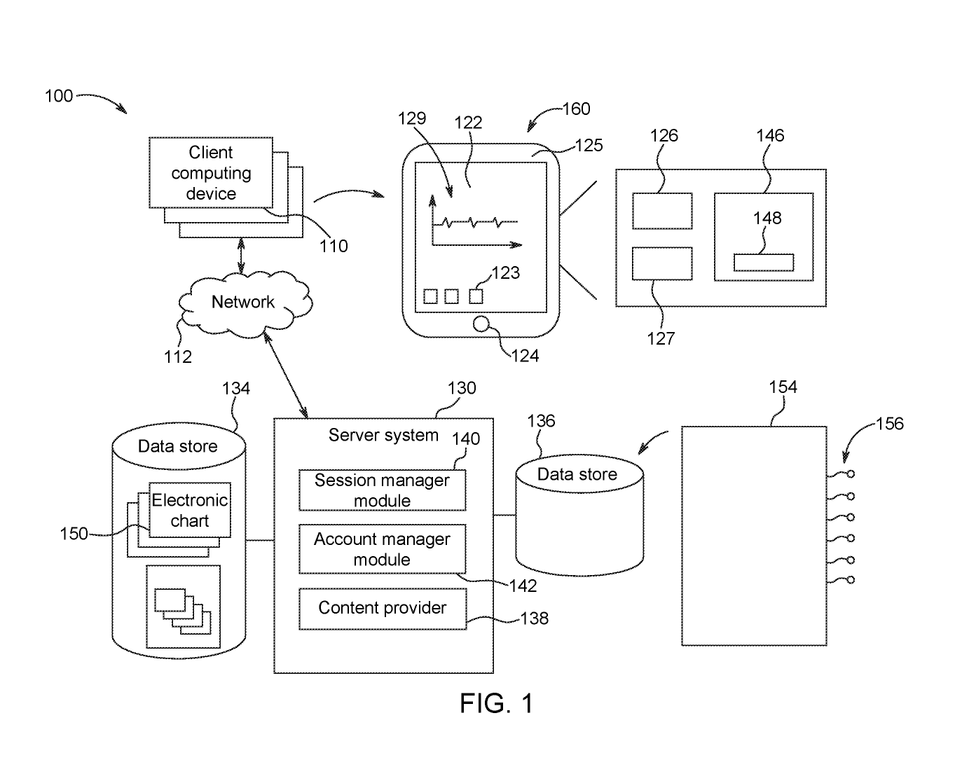

FIG. 1 is a block diagram illustrating a system 100 formed in accordance with embodiments herein. The system 100 includes one or more client computing devices 110 that are capable of communicating over a network 112 with a server system 130. The server system 130 may include one or more web servers and, optionally, one or more application servers. The server system 130 may host a web application and have the tools, application program interfaces (APIs), and scripts, among other things, that may be used for the web application. In some embodiments, a web application includes a web site or web page that allows a user to view waveform data. The server system 130 may be only a single server or include a plurality of different servers that communicate with one another and the client computing devices 110 over the network 112. The server system 130, in some embodiments, is configured to receive and interpret requests through the network 112 from the client computing devices 110 or, more specifically, from software applications 146 of the client computing devices 110. The server system 130 is also configured to respond to the requests and transmit data to the client computing devices 110 in a predetermined format (e.g., HTML format). In some cases, the server system 130 and the client computing devices 110 may form a cloud-type computing system (e.g., public cloud, private cloud, or hybrid cloud).

The network 112 represents any one or combination of multiple different types of networks, such as cable networks, the Internet, private intranets, local area networks, wide area networks, wireless networks, and the like. In particular embodiments, the network 112 is the network of a healthcare facility (e.g., hospital) that allows access to authorized users (e.g., doctors, nurses, technicians, and the like) for reviewing medical information.

The client computing devices 110 may be implemented as any number of types of computing devices. These devices may include, for instance, personal computers (PCs), tablet computers, notebook computers, laptop computers, smart phones, electronic book readers, and so forth. In particular embodiments, the client computing devices 110 may include portable or handheld devices, such as tablet computers, notebook computers, laptop computers, and smart phones (e.g., iPhones). A portable or handheld device is relatively lightweight (e.g., less than six pounds) such that an average adult individual may hold and re-orient the device during the course of its intended operation. In the illustrated embodiment, the computing device is a tablet computer 160. A user may be able to orient the portable device in a first layout orientation (e.g., portrait or vertical orientation) and in a second layout orientation (e.g., landscape or horizontal orientation). Data displayed on the portable devices may include, among other things, waveform data. The data may be reconfigured (e.g., re-sized) after the orientation of the portable device has changed. In some embodiments, the computing devices may be used for personal use and for business purposes.

The portable devices may also be configured to operate application programs, such as web browsers, mobile applications, or other software programs, that are capable of retrieving waveform data and displaying the waveform data through a communication network. The application program may be, for example, a third-party program (e.g., Google Chrome), a third-party mobile application (which may or may not include the same functionalities as a conventional web browser), or an application program configured for the enterprise using the application program. For instance, the application program may be developed using WebView. The communication network may include a private network, public network, or both. Non-limiting examples of web browsers include, such as Microsoft's Internet Explorer, Google Chrome, Mozilla Firefox, Opera, and Apple's Safari. The application programs may also be similar to mobile applications (referred to as “apps”). Optionally, the application programs may be configured to work with sub-applications or scripts (e.g., plug-ins or extensions) that are executed from within the application program or in concert with the application program. The sub-application runs or is executed concurrently with the application program. Optionally, the sub-application may be stored within the client computing system and/or the server system.

Application programs are typically third-party software that retrieve, present, and communicate information through the network. Application programs are configured to communicate with the server system 130 over the network 112. The application programs may communicate using, for example, a known protocol (e.g., Hypertext Transfer Protocol (HTTP) or HTTP-secure (HTTPS)). More specifically, the application programs may send requests (e.g., HTTP requests) for information to any web-accessible internet address. The application programs may also display the information in accordance with a predetermined format (e.g., HTML format). The sub-applications may be launched from within the application program and, optionally, communicate with the server system 130 to retrieve information that may be displayed to the user through the application program. Embodiments set forth herein may be implemented, at least in part, using an application program, a sub-application associated with the application program, or other software program having computer executable code.

In some embodiments, the server system 130 is configured to present a site (e.g., a website) that is capable of handling requests from one or more users and transmitting, in response, various pages (e.g., web pages) that are rendered at the client computing devices 110. For instance, the site can be any type of site that allows a user to view waveform data and, optionally, supports user interaction. In another example, the server system 130 may provide applications or sub-applications for the client computing devices 110 to download, store, and run locally. The server system 130 may additionally or alternatively interact with the client computing devices 110 to provide content in other ways.

As one example, the server system 130 may present an institutional website that allows access to medical data for a user that is authorized to view the medical data. The server system 130 may include, among other things, a content provider module 138, a session manager module 140, and an account manager module 142. The modules 138, 140 and 142, as well as other modules or services described herein, may be implemented by one or more processors performing program instructions to perform the operations described herein. The program instructions may be stored in data stores 134 or 136. The server system 130 interacts with one or more memories or data stores 134 and 136 in various manners as explained herein. One or both of the memories or data stores 134 and 136 may store program instructions to direct one or more processors to carry out the instructions described herein.

The data stores 134, 136 (as well as memory at the client computing devices 110) may also store various information, such as account-specific information about users of the site. The data store 134 may also store one or more catalogs related to items that may be viewed by the user. For example, web content (text, videos, pictures, and other content) may be stored therein. Content may also include electronic chart files 150 (e.g., health-monitoring graphs) having waveform data as described below. The data associated with different web content may be transmitted to client computing devices 110 in response to individual client request designating location of such web content. It is recognized that the various content may be stored at locations distributed between various data storage areas, geographic locations, file structures, recommendation services, e-commerce catalogs and the like.

During operation, the session manager module 140 maintains network sessions with various client computing devices 110. The session manager module 140 responds to requests from the client computing devices 110 by providing authenticated and unauthenticated network resources. The session manager module 140 reviews incoming requests and determines whether the incoming requests seek access to authenticated or unauthenticated network resources. Requests for an authenticated network resource involve (e.g., require) privilege authentication before the session manager module 140 responds by granting access to the authenticated network resource. When privilege authentication is warranted/needed, the account manager module 142, returns an account lookup response including a prompt for non-sign-in credentials. The non-sign-in credentials corresponding to a type of content maintained in connection with user accounts. The non-sign-in credentials represent user specific information that is unique to a user and is not used as sign-in credentials for a corresponding network service. Optionally, the account manager module 142 may return an account authentication page including at least one of i) a sign-in credential fields or ii) a create new account option. Based on the user's entries at the account authentication page (as explained herein), the account manager module 142 the presents an account lookup response (e.g., when incorrect sign-in credentials are entered). The account manager module 142 may authorize the user to view the medical data, such as the waveform data described herein.

Also shown in FIG. 1, the tablet computer 160 includes a user display 122, which may be a touchscreen in some embodiments that is configured to identify and locate a touch from a user's finger or stylus. The user display 122 is framed by a housing 125 of the table computer 160. The user display 122 defines an area that may present virtual user-selectable elements 123 that may be selected by the user on the user display 122. Alternatively or in addition to the user-selectable elements 123, a user may select tangible or physical user-selectable elements 124 (e.g., buttons, switches, and the like).

Also shown in FIG. 1, the tablet computer 160 may include one or more processors 126 and computer-readable storage media 127. The computer-readable storage media 127 may store program instructions or computer code for a display application 146. The display application 146 is configured to display an electronic chart 129 on the user display 122. In some embodiments, the display application 146 is configured to analyze a health-monitoring graph to determine whether the chart is sufficiently displayed (e.g., correct aspect ratio) to the user. In some embodiments, the computer-readable storage media 127 may store program instructions or computer code for a sub-application 148. Optionally, the sub-application 148 may be a plug-in or extension that is executable within or by the display application 146.

In some embodiments, the system 100 may include a monitoring system 154 that is communicatively coupled to sensors 156 that are configured to detect measurements, such as from an individual (e.g., a patient), and communicate the measurements to the system 154 as waveform signals. In particular embodiments, the measurements are physiological measurements. The sensors 156 may be configured to detect different physiological measurements, such as a heart rate, body temperature, blood pressure, respiratory rate, electrical activity, or intrauterine pressure. The monitoring system 154 may communicate data to the server system 130 that is based on the detected physiological measurements. For example, the data may include the chart documents described herein and/or may include data for forming the chart documents.

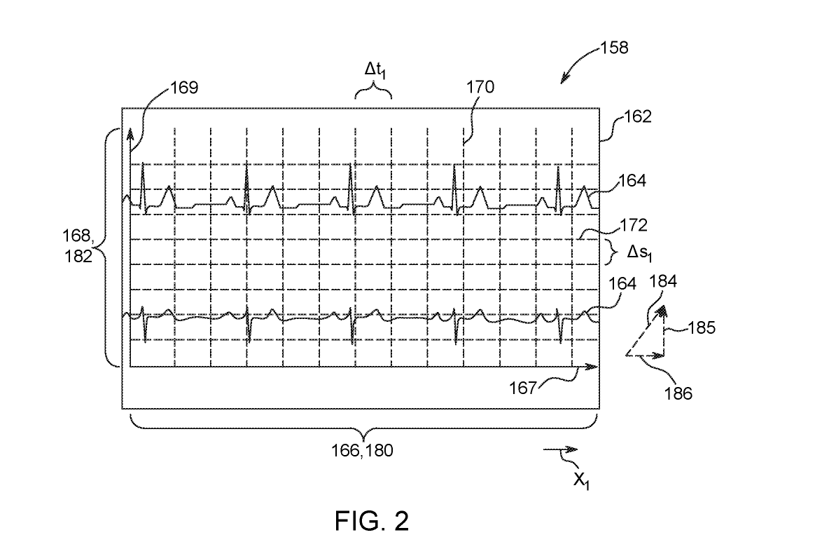

FIG. 2 illustrates an exemplary health-monitoring graph 158. The various features described herein may be stored in one or more packets or files, such as the electronic chart files 150 (FIG. 1). The chart file 150 may include data that represents a health-monitoring graph that is configured to be presented to a user on the client computing device 130 (FIG. 1). The health-monitoring graph 158 is shown in FIG. 2 at a desired display. For example, the health-monitoring graph 158 may be shown at a desired aspect ratio, such as an aspect ratio that is consistent with an established standard. The health-monitoring graph 158 may include one or more graphs 162 having one or more waveforms 164 superimposed thereon. It should be noted that the health-monitoring graph 158 may include real-time measurements or may be a past recording of measurements. As described herein, an overall presentation of the health-monitoring graph 158 or particular features (e.g., the waveforms 164) of the health-monitoring graph 158 may become distorted or mis-proportioned relative to the desired standard.

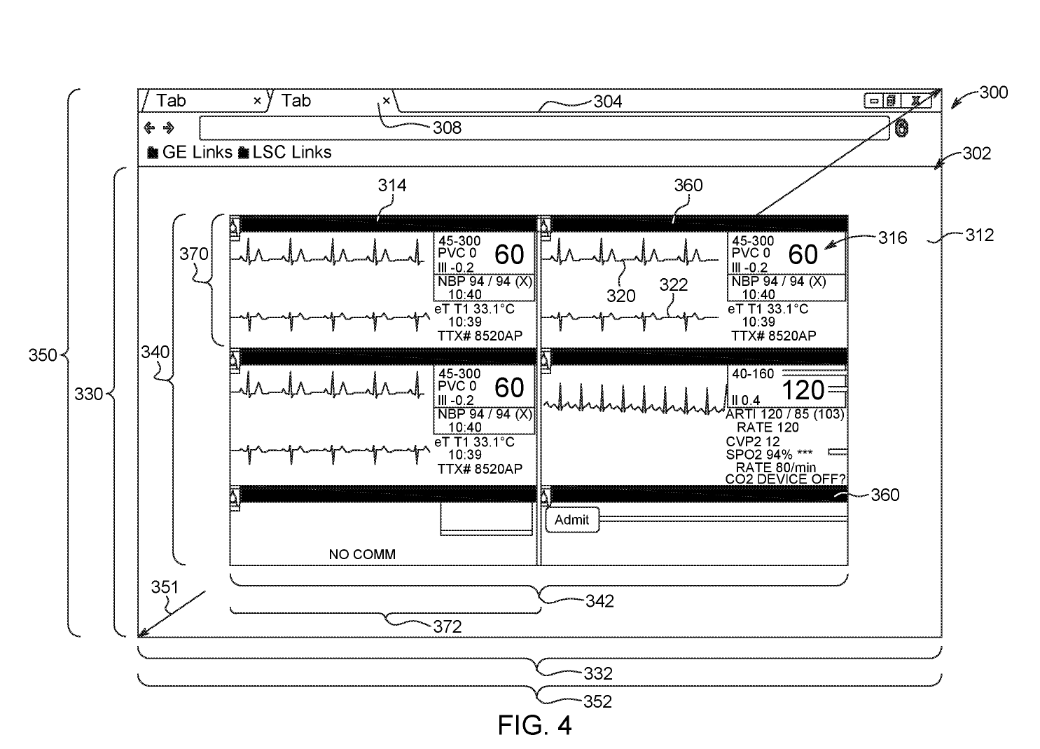

In the illustrated embodiment, the graph 162 constitutes a two-dimensional area upon which the waveforms 164 will be positioned. It is contemplated, however, that three-dimensional graphs may also be displayed by embodiments set forth herein. The graph 162 has a first dimension 166 and a second dimension 168 that extend or are measured perpendicular to each other. In the illustrated embodiment, the first and second dimensions 166, 168 represent time and signal dimensions, respectively, but other units may be used in other embodiments. In FIG. 1, the first and second dimensions 166, 168 are shown as graph axes or lines 167, 169, respectively. In other embodiments, however, the first and second dimensions 166, 168 may not be displayed on the graph 162. For example, the health-monitoring graphs 316 in FIG. 4 do not illustrate graph axes.

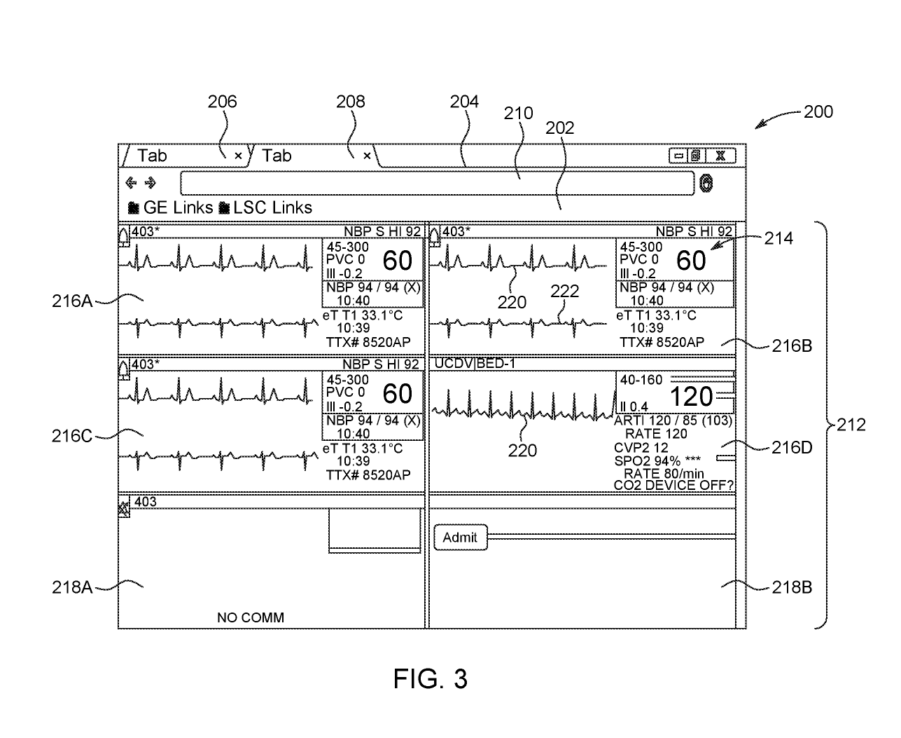

Optionally, the graph 162 may have a pattern of visual cues or indicators that facilitate a user's analysis of the waveforms 164. In other embodiments, such as those shown in FIGS. 3-5, the indicators are not shown on the graph 162. The graph 162 includes first indicators 170 along the first dimension 166. A spacing between adjacent first indicators 170 may represent a predetermined amount of elapsed time as indicated by Δt₁. The rate at which the waveform 164 appears to move through the graph 162 (e.g., units of distance/time, such as 25 mm/s) may be referred to as sweep speed or recording speed. The sweep speed correlates to a horizontal sensitivity in FIG. 2. The sweep speed exists with or without indicators along the first dimension 166.

Also shown in FIG. 2, the graph 162 may include second indicators 172 along the second dimension 168. The second indicators 172 may indicate a predetermined scaling. In particular embodiments, the second indicators 172 are spaced apart in regular, predetermined intervals. In the illustrated embodiment, the second indicators 172 form grid lines that extend in a horizontal direction along the first dimension 166. The vertical spacing between adjacent horizontal grid lines represents a predetermined amount of change, or Δs₁. In the illustrated embodiment, the change relates to signals and, in particular, to millivolts (mV). The rate of change may correlate to the vertical sensitivity, which may be defined as a ratio of distance to signal (e.g., mm/mV). The second indicators 172 may be other visual cues in alternative embodiments, such as dots patterned across the graph 162 or tics located along the second dimension 168. In some embodiments, the second indicators 162 may also be visually differentiated from each other as desired.

In the illustrated embodiment, the waveform 164 constitutes a plurality of data points plotted on the graph 162 to form a tracing. The waveform 164 may be plotted with respect to the first and second indicators 170, 172 of the graph 162. A shape or path of the waveform 164 is based upon the horizontal and vertical sensitivities. For example, the waveform 164 is based upon the physiological signals obtained through the sensors, the sweep speed, and the signal scaling or interval Δs₁.

The graph 162 has a width 180 measured along the first dimension 166 that may be measured from the intersection of the axes 167, 169 to the tip of the axis 167. The graph 162 has a height 182 that may be measured from the intersection of the axes 167, 169 to the tip of the axis 169. Alternatively, the graph 162 may be measured by the borders of the graph 162. For example, if the graph 162 has a rectangular shape, the height and width of the rectangle may be measured along the sides of the graph 162. A ratio of the height 182 to the width 180 may be referred to as the aspect ratio of the graph 162. The waveform 164 may also have an aspect ratio, which may be the ratio of the signal scaling to the sweep speed (or the vertical sensitivity to the horizontal sensitivity). The aspect ratio is represented as a vector 184 that includes a scaling (or vertical sensitivity) component 185 and a sweep speed (or horizontal sensitivity) component 186 in FIG. 2.

As time elapses and more physiological signals are obtained, the graph 162 appears to move in the direction X₁. More specifically, the waveform 164 appears to extend in the direction X₁ such that it appears that new data points are added along the right-hand side in FIG. 2 and old data points are removed from the graph 162. As such, wave features 186 (e.g., PQRST waves) moves from left to right in a direction X₂ that is opposite the direction X₁. The first indicators 170 of the graph 162 may also shift along the first dimension 166 at the recording speed.

The health-monitoring graph 158 may occupy an entirety of the viewable area of the user display 122 (FIG. 1) or may occupy only a portion of the viewable area of the user display 122. The health-monitoring graph 158 comprises a plurality of frames that are displayed at a frame frequency. In some embodiments, the health-monitoring graph 158 is configured to resemble a paper strip chart that moves through the viewable area of the user display 122. As such, the health-monitoring graph 158 may appear to move continuously at the sweep speed. To this end, the computing device may be configured to generate a series of frames at a predetermined frame rate or frame frequency (60 Hz) and display each frame in the user display 122. For example, each frame in the user display 122 may comprise a plurality of pixels in which each pixel has an address in the user display 122. The addresses may be defined by coordinates (e.g., x-y coordinates) or vectors.

FIG. 3 shows a user display or screen 200 having a viewable area 202 in accordance with one embodiment. The user display 200 may be similar to the user display 122 (FIG. 1). As shown in FIG. 3, the viewable area 202 includes an application program 204 that occupies an entirety of the viewable area 202. The application program 204 may be similar to, for example, a web browser, such as Google Chrome or other known web browsers. The application program may also be similar to mobile apps. The application program 204 includes a plurality of tabs or panels 206, 208 allowing an individual to open multiple web sites with a single application program. Each of the tabs 206, 208 includes an address bar 210 and a viewport 212, among other possible features. The viewport 212 may be the area of the application program 204 (or an individual tab 206, 208) that shows the information provided by the web page or web site. In FIG. 3, the viewport 212 is completely occupied by a chart document 214 that includes a plurality of health-monitoring graphs 216A, 216B, 216C, 216D and administrative sub-windows 218A, 218B. The chart document 214 may be supplied by the server system 130 (FIG. 1) to the client computing device 110 (FIG. 1). The chart document 218 may correspond to the chart file 150 (FIG. 1). In some embodiments, the chart document 218 is similar to a multimedia file, such as a movie file.

Each of the health-monitoring graphs 216A-216D may include similar features as the health-monitoring graph 158 (FIG. 2). The administrative sub-windows 218A, 218B may have open areas or borders or user-selectable buttons for the user to press through the touchscreen or using a peripheral device. The health-monitoring graphs 216A-216D and the administrative sub-windows 218A, 218B may be positioned side-by-side as tiles such that the chart document 218 has a rectangular shape. In the illustrated embodiment, the chart document 214 includes multiple health-monitoring graphs and administrative sub-windows. It should be understood that other chart documents may include a different number of health-monitoring graphs and/or a different number of administrative sub-windows. For example, a chart document 214 may include only a single health-monitoring graph in some embodiments without any administrative sub-windows. In FIG. 3, each of the health-monitoring graph 216A-216C has two waveforms 220, 222 that have a sufficient aspect ratio. The health-monitoring graph 216D has only a single waveform 222. Each of the health-monitoring graphs 216A-216D also includes numerical and textual information in the top-right hand corner of the corresponding health-monitoring graph. Like the waveforms, the numerical and textual information may be monitored to determine whether the information is displayed properly or improperly to a viewer.

FIGS. 4-7 illustrate screens that display waveforms with insufficient aspect ratios. FIGS. 4-7 may also illustrate screens that have an insufficient horizontal sensitivity, an insufficient vertical sensitivity, and/or other graph characteristic. The screens may be similar or identical to the screen 200 (FIG. 3). In FIGS. 4-7, reference numbers will be similar to the reference numbers used in FIG. 3. FIG. 4 illustrates a screen 300 in which the viewable area 302 is entirely occupied by an application program 304 (e.g., web browser) having a tab 308 in view. The viewable area (or device area) 302 has a screen height 350 and a screen width 352. The viewable area 302 also has a screen diagonal 351.

A viewport 312 of the application program 304 is only partially occupied by a chart document 314. The viewport 312 has a viewport height 330 and a viewport width 332. The viewport 312 also has a viewport diagonal, which is not shown for illustrative purposes. The viewport 312 may occupy an identifiable section of the viewable area 302. For example, a location of the viewport (e.g., coordinates) may be obtainable using, for example, information from the application program or the client-computing device. The chart document 314 has a chart height 340 and a chart width 342. Similar to the viewport 312, the chart document 314 may occupy an identifiable section of the viewable area 302 or of the viewport 312.

As shown, the chart width 342 is about 60% of the viewport width 332 and the chart height 340 is about 45% of the viewport height 330. The viewport width 332 is about 100% the screen width 352, and the viewport height 330 is about 90% the screen height 350. In other embodiments, the viewport 312 may occupy only a portion of the viewable area 302.

In FIG. 4, the waveforms 320, 322 have a perceived aspect ratio that is not acceptable relative to a standard aspect ratio. For example, the perceived aspect ratio may be about 0.30 and the standard aspect ratio is 0.4±0.08. As such, the perceived aspect ratio of 0.30 is less than an acceptable minimum standard aspect range of 0.32.

Embodiments may be configured to monitor a perceived graph characteristic (e.g., vertical sensitivity, horizontal sensitivity, or aspect ratio) and determine that the perceived graph characteristic is improper relative to the standard graph characteristic. For example, a perceived aspect ratio may be repeatedly compared to the standard aspect range. The perceived aspect ratio may be compared to a maximum acceptable aspect ratio and a minimum acceptable aspect ratio. If the perceived aspect ratio is less than the minimum acceptable aspect ratio or greater than the maximum acceptable aspect ratio, then the perceived aspect ratio does not satisfy the standard aspect range. In some embodiments, the perceived aspect ratio is only compared to the standard aspect range after a graph-changing event. Graph-changing events may include a change of device orientation, a change in zoom level of the application program, or a change in zoom level of the device.

The perceived graph characteristic may be monitored and determined using one or more processes. In some embodiments, the perceived graph characteristic may be calculated using dimensions of an area of the health-monitoring graph as displayed on the screen (e.g., viewable area). For example, one or more perceived graph characteristics may be calculated using a chart height, chart width, or chart diagonal. As another example, the perceived aspect ratio may be calculated by determining a vertical sensitivity of the waveform as displayed on the screen and a horizontal sensitivity of the waveform as displayed on the screen. The perceived aspect ratio may be compared to the standard aspect range to determine whether the perceived aspect ratio is improper relative to the standard aspect range.

However, it should be understood that monitoring and determining the perceived graph characteristic may include monitoring and determining a quality or characteristic that is directly related to the perceived graph characteristic without calculating the perceived graph characteristic. For example, assuming that the perceived graph characteristic is the perceived aspect ratio of the waveform, the chart height 340 and the chart width 342 may form a chart ratio that directly relates to the perceived aspect ratio. For example, the chart ratio and the aspect ratio of the waveform may have a known direct relationship (e.g. 2:1) when the aspect ratio is at a standard aspect ratio. If the chart ratio is less than a minimum acceptable chart ratio or greater than a maximum acceptable chart ratio, then the perceived aspect ratio may not satisfy the standard aspect range. In another example, a graph height 370 and a graph width 372 of a single health-monitoring graph 316 may form a graph ratio that relates to the perceived aspect ratio. Thus, if the graph ratio is less than a minimum acceptable graph ratio or greater than a maximum acceptable graph ratio, then the perceived aspect ratio may not satisfy the standard aspect range.

It should be understood that aspect ratios may be calculated or inferred using different methods. In some embodiments, dimensions other than or in addition to the height and widths may be used. For example, the viewport diagonal 351 that extends across the viewport 312, a chart diagonal that extends across the chart document 314, or a graph diagonal that extends across a health-monitoring chart 316 may be used to determine perceived graph characteristics, such as the aspect ratios. It should also be understood that the dimensions described above (e.g., height, widths, diagonals) are not necessarily distance values, such as inches or centimeters. Instead, the dimensions may be represented as, for example, percentages of the same dimension as the viewport or the viewable area. For example, the chart height may be 80% of the viewport height and the chart width may be 90% of the viewport width. Using this and other information, perceived graph characteristics may be determined.

Aspect ratios may also be determined by identifying the pixels of the client-computing device that correspond to the waveforms 320, 322 and comparing the shape of the waveform (as determined by the device pixels) to a designated shape of the waveform when the standard aspect ratio is used. Variations in the shape may correspond to different aspect ratios. Other graph characteristics may also be determined by identifying the relevant pixels and calculating the graph characteristics.

In some embodiments, the perceived aspect ratio may be determined without determining dimensions of the health-monitoring graph or the chart document and/or without calculating the perceived aspect ratio. The perceived aspect ratio may be determined using information that is obtained using the application program. For example, a variety of characteristics, such as a zoom level, a viewport size (e.g., height, width, diagonal), CSS pixels, a device pixel ratio, the device pixel ratio relative to the zoom level, and a screen size, may be detected using the application program and computer code (e.g., javascript). It is noted that, in some instances, that the application program may not provide a value (or values) to the desired information, but the application program may provide other information that can be used to determine the desired information. For example, although the application program may not provide the zoom level, the zoom level may be calculated by detecting other information through the application program.

In some embodiments, the determining operations may include using a database or look-up table. The database may include information that identifies the perceived graph characteristic based on known parameters. For example, the perceived aspect ratio may be identified using the table based on a type of device, an orientation of the device, a type of application program, a zoom level of the application program, a size of the viewable area (or screen size of the device), and/or a viewport size. Application programs may have a predetermined number of zoom levels, such as 400%, 300%, 250%, 200%, 175%, 150%, 125%, 100%, 75%, 50%. Trials may be performed (e.g., by the programmer or by the server system) to determine what the perceived aspect ratio is for the waveform when the application program has a designated zoom level. For example, it may be determined using the database that if Application Program A has a zoom level of 100%, then the perceived aspect ratio is 0.30. However, if Application Program A has a zoom level of 150%, then the perceived aspect ratio is 0.44.

Optional information to the above examples may include the type of device, the orientation of the device, the size of the viewable area, and/or the viewport size. It may also be determined through the database (or another database) that if the perceived aspect ratio is 0.30 on Application Program A, then the zoom level may be changed to Y% so that the perceived aspect ratio is acceptable. It may also be determined through the database (or another database) that if the perceived aspect ratio is 0.30 on Application Program A when the viewport has a designated viewport size, then the zoom level may be changed to Y% and the viewport size may be changed to Z% so that the perceived aspect ratio is acceptable.

Embodiments may also be configured to notify the user that the perceived graph characteristic does not satisfy the standard graph range. The client-computing device may initiate one or more notifications that warn the user. For example, the client-computing device may provide audible information (e.g., beeps, tones, or voice instructions) to the user through an audio system of the device or system. The client-computing device may display a color-coded alert to the user on the screen. The client-computing device may display text to the user. For example, a pop-up sub-window may appear to the user.

In the illustrated embodiment of FIG. 4, warning bars 360 appear along a top border of each of the health-monitoring graphs 316. It should be understood that the warning bars 360 may appear at other positions, such as along different borders. The warning bars 360 may also appear over the waveforms 320, 322. Optionally, the warning bars 360 may flash at a predetermined rate. In an exemplary embodiment, the warning bars 360 may be colored. For example, the warning bars 360 may be green, red, or another color. In some embodiments, the warning bars 360 are color-coded. For example, the color green may inform the user that the aspect ratio is less than the minimum acceptable aspect ratio and the color red may inform the user that the aspect ratio is greater than the maximum acceptable aspect ratio.

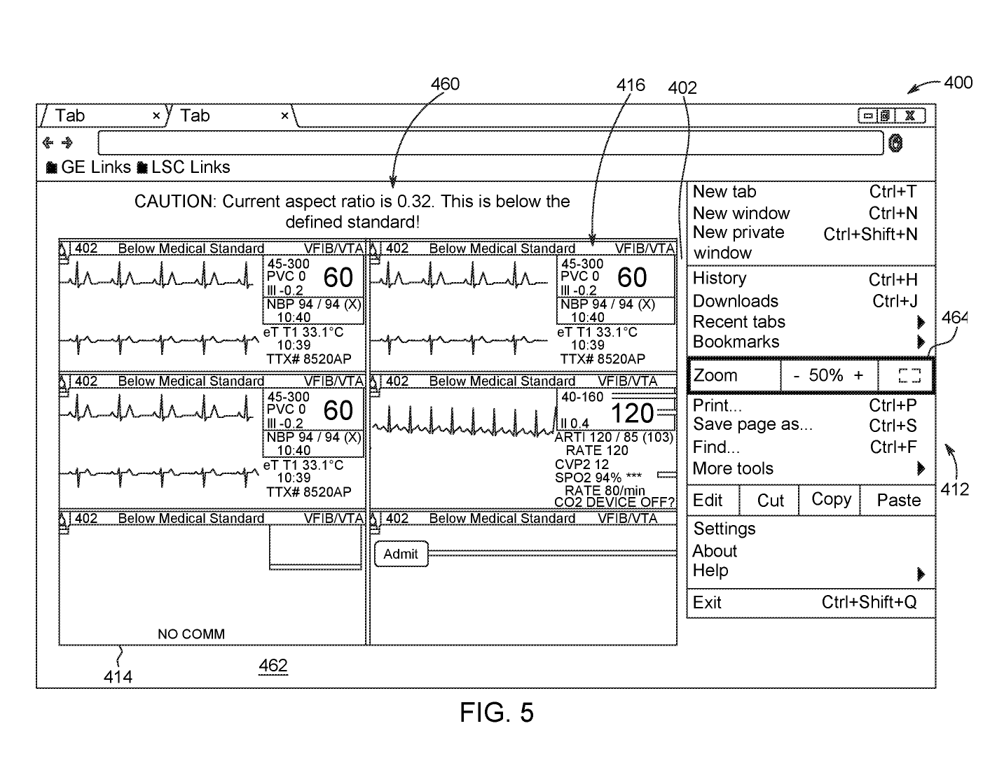

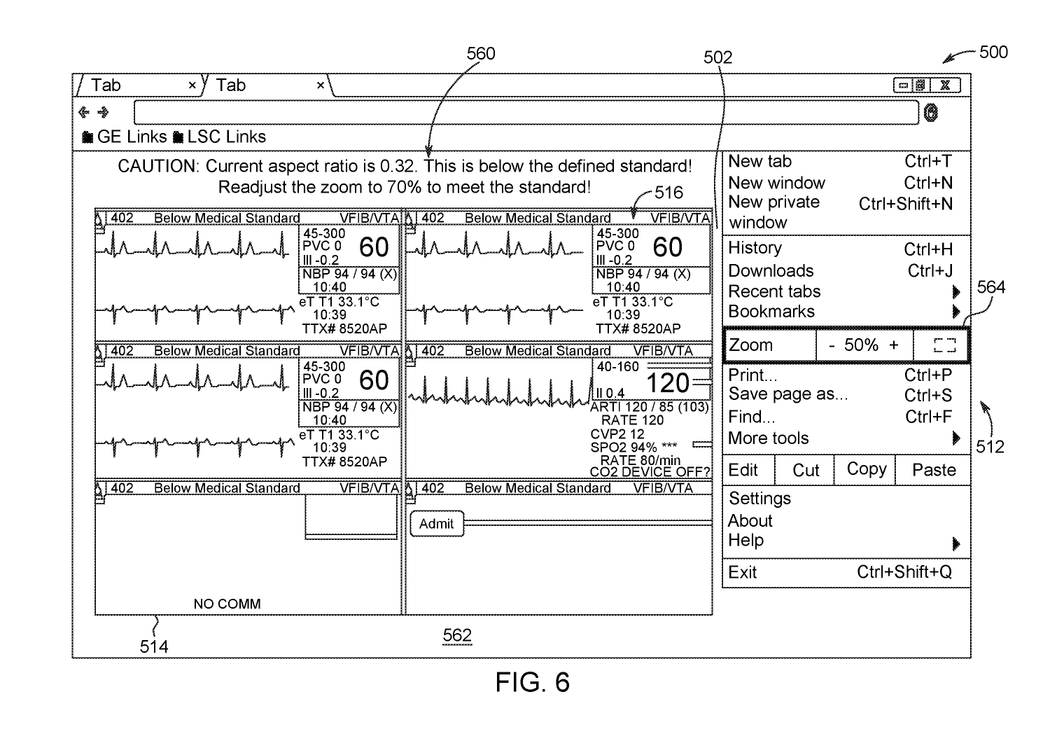

FIG. 5 illustrates a screen 400 having a viewable area 402 in which a health-monitoring graph 416 has an improper aspect ratio. As shown in FIG. 5, a textual notification 460 is provided in white space 462 of the viewport 412 that surrounds the chart document 414. The textual notification 460 is “CAUTION: Current aspect ratio is 0.32. This is below the defined standard!” In the illustrated embodiment, the user may select a zoom level 464 from among the options provided by the application program. In FIG. 6, the zoom level 564 is currently at 50%. After the zoom level is changed, the aspect ratio may be re-calculated to determine if the aspect ratio is proper.

FIG. 6 illustrates a screen 500 having a viewable area 502 in which a health-monitoring graph 516 also has an improper aspect ratio. As shown in FIG. 6, a textual notification 560 is provided in white space 562 of the viewport 512 that surrounds the chart document 514. The textual notification 560 is “CAUTION: Current aspect ratio is 0.32. This is below the defined standard!” However, the textual notification 560 may also include instructions for changing a zoom level of the application program to obtain the desired aspect ratio. For example, the textual notification 560 includes the statement: “Readjust the zoom to 70% to meet the standard.” The user may select the recommended zoom level 564 from among the options provided by the application program. In FIG. 6, the zoom level 564 is currently at 50%, but the application program enables the zoom level to be adjusted to another zoom level.

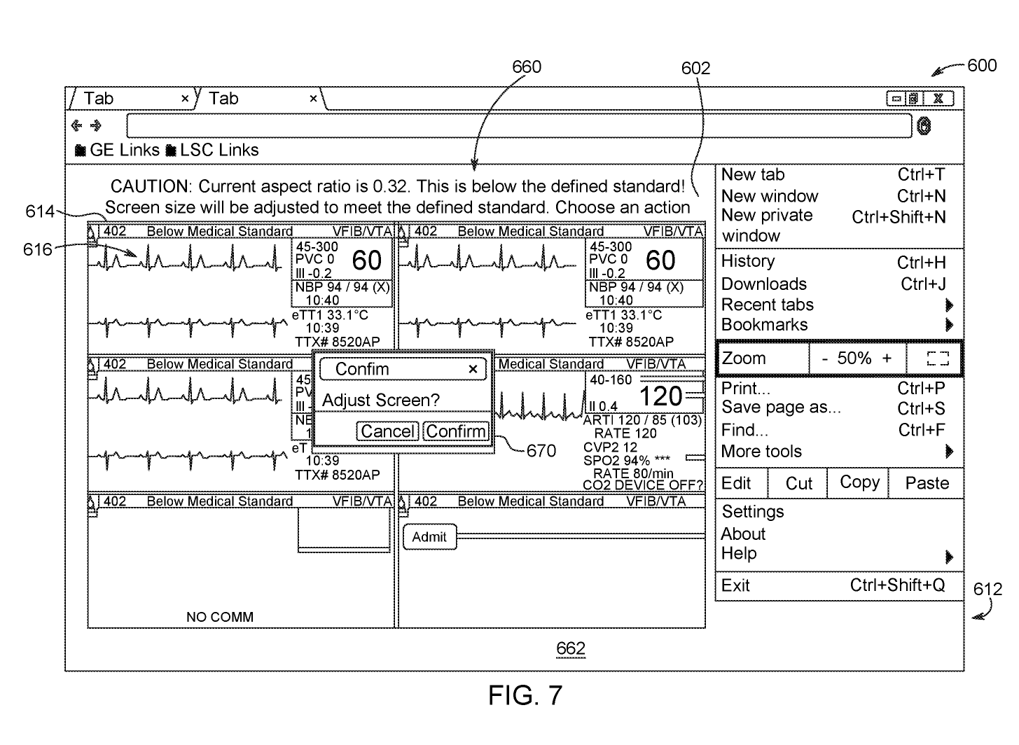

FIG. 7 illustrates a screen 600 having a viewable area 602 in which a health-monitoring graph 616 also has an improper aspect ratio. As shown in FIG. 7, a textual notification 660 is provided in white space 662 of the viewport 612 that surrounds the chart document 614. The textual notification 660 is “CAUTION: Current aspect ratio is 0.32. This is below the defined standard!” Optionally, the textual notification 660 may also notify the user that the system can automatically adjust the screen so that the aspect ratio is sufficient. For example, the screen 600 includes a prompting window 670 to confirm that the screen should be adjusted. More specifically, the prompting window 670 may query the user whether the screen should be adjusted. By selecting “Continue,” the system will adjust the screen size so that the aspect ratio is proper. Alternatively, the user may select “Cancel” and continue using the improper aspect ratio or may select a different zoom level from among a plurality of options.

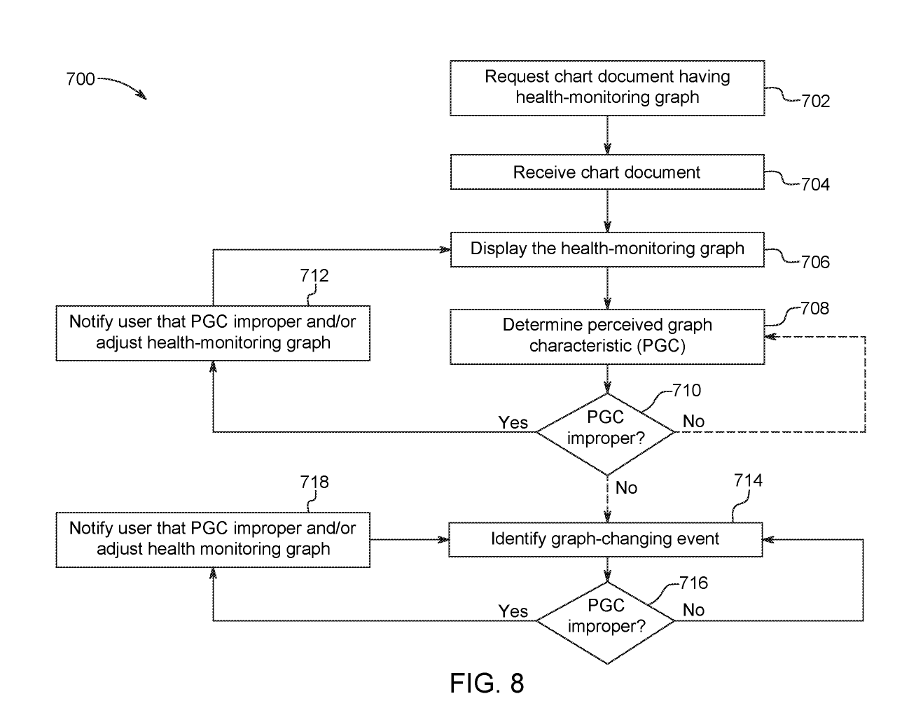

FIG. 8 is a flowchart illustrating a method 700 in accordance with an embodiment. The method 700, for example, may employ structures or aspects of various embodiments (e.g., systems and/or methods) discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion.

The method 700 may include requesting a chart document at 702. In some embodiments, the user may activate his or her client-computing device and initiate a program session (e.g., browsing session) by activating an application program. Optionally, the user may log into a private network as an authorized user. For example, the user may enter in his or her login and password. Alternatively or in addition to the above, the user may use a keycard and/or biometric data to access the private network as an authorized user. In other embodiments, the application program is not initiated and, instead, a private application is activated. The private application may or may not have functions or capabilities that are similar to an application program. The chart document may be requested, at 702, by selecting a chart document from a plurality of chart documents. A server system may retrieve the requested chart document. Alternatively, the chart document may be stored on a local database and accessed when selected by the user.

The chart document may be received, at 704, and displayed, at 706, on a screen of a user display of a client-computing device. The chart document may be received at the client-computing device, such as a portable device. When the chart document is displayed, at 706, a health-monitoring graph may also be displayed. After initially displaying, at 706, the health-monitoring graph, a perceived graph characteristic of the health-monitoring graph may be determined at 708. The perceived graph characteristic may be predetermined in accordance with some embodiments. The perceived graph characteristic may be related to at least one of the waveform as displayed on the screen or an area of the health-monitoring graph as displayed on the screen. It is noted that only a single perceived graph characteristic may be determined or a plurality of perceived graph characteristics may be determined at 708.

At 710, it may be queried whether the perceived graph characteristic is improper relative to a standard graph characteristic. For example, the perceived graph characteristic may be compared to a standard graph characteristic at 710. If the perceived graph characteristic fails the standard graph characteristic or is insufficient relative to the standard graph characteristic, then the perceived graph characteristic is designated as improper (e.g., not sufficient). If the perceived graph characteristic is improper, the method 700 may then, in response to determining that the perceived graph characteristic is improper, at least one of notify the user that the perceived graph characteristic is improper or adjust the health-monitoring graph on the screen at 712. In some embodiments, the health-monitoring graph may be automatically adjusted, at 712, so that the perceived graph characteristic is proper relative to the standard graph characteristic. In some embodiments, the health-monitoring graph may be automatically adjusted, at 712, in a manner that makes the perceived graph characteristic closer to the standard graph characteristic. The method 700 may then move to the displaying operation at 706 and the process may repeat.

If the perceived graph characteristic is proper, then the method 700 may, at least, move to two different operations. For example, the method 700 may return to the displaying operation, at 706, or the determining operation, at 708. Alternatively, the method 700 may pause until a graph-changing event is identified at 714. The graph-changing event may be any event that possibly changes the area of the health-monitoring graph or the waveform of the health-monitoring graph. For example, the graph-changing event may be at least one of a change in zoom level or a change in orientation. In some cases, the zoom level may change when the orientation of the client-computing device is changed.

At 716, it is queried whether the perceived graph characteristic of the health-monitoring graph is improper. If improper, the method 700 may then, in response to determining that the perceived graph characteristic is improper, at least one of notify the user that the perceived graph characteristic is improper or adjust the health-monitoring graph on the screen at 718. The method 700 may then return to identify graph-changing events at 714 and the process is repeated. If the perceived graph characteristic is proper, the method 700 may return to identify graph-changing events at 714.

As used herein, the terms “computer” or “computing system” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer” or “computing system.”

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes described herein. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine. The program is compiled to run on both 32-bit and 64-bit operating systems. A 32-bit operating system like Windows XP™ can only use up to 3 GB bytes of memory, while a 64-bit operating system like Window's Vista™ or 7™ can use as many as 16 exabytes (16 billion GB).

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
a plurality of sensors that are configured to detect physiological data from an individual;
a user display configured to present viewable information to a user of the system that is based on the physiological data;
a processor and a storage medium that is configured to store program instructions accessible by the processor, wherein, responsive to execution of the program instructions, the processor is configured to:
display a health-monitoring graph on a screen of the user display, the health-monitoring graph including a waveform that represents the physiological data that is plotted with respect to horizontal and vertical axes;
monitor a perceived graph characteristic of the health-monitoring graph, the perceived graph characteristic being related to at least one of the waveforms as displayed on the screen or an area of the health-monitoring graph as displayed on the screen; and
determine the perceived graph characteristic is improper relative to a standard graph characteristic for displaying the physiological data;
wherein, in response to determining that the perceived graph characteristic is improper, the processor is configured to at least one of notify the user that the perceived graph characteristic is improper or adjust the health-monitoring graph on the screen so that that the perceived graph characteristic is proper relative to the standard graph characteristic.

2. The system of claim 1, wherein the perceived graph characteristic is at least one of an aspect ratio, a channel width, a channel height, a vertical gain, or a sweep speed.

3. The system of claim 1, wherein displaying the health-monitoring graph to the user includes displaying the health-monitoring graph to the user through an application program that is configured to retrieve data for the health-monitoring graph through a communication network.

4. The system of claim 3, wherein determining the perceived graph characteristic is improper relative to the standard graph characteristic includes obtaining size information through the application program, the size information being at least one of a zoom level of the application program, a viewport size of the application program, or a device pixel ratio.

5. The system of claim 3, wherein determining the perceived graph characteristic is improper relative to the standard graph characteristic is performed by a sub-application invoked by the application program.

6. The system of claim 1, wherein monitoring the perceived graph characteristic includes identifying that a graph-changing event has occurred and, in response to identifying that a graph-changing event has occurred, determining the perceived graph characteristic.

7. The system of claim 1, wherein notifying the user includes at least one of (a) providing audible information to the user through an audio system of the device or system; (b) displaying a non-textural alert to the user on the screen; (c) or displaying a textual alert to the user.

8. A method comprising:
displaying a health-monitoring graph on a screen of a computing system, the health-monitoring graph including a waveform that represents physiological data of an individual that is plotted with respect to horizontal and vertical axes;
monitoring a perceived graph characteristic of the health-monitoring graph, the perceived graph characteristic being related to at least one of the waveform as displayed on the screen or an area of the health-monitoring graph as displayed on the screen; and
determining the perceived graph characteristic is improper relative to a standard graph characteristic for displaying the physiological data;
wherein, in response to determining that the perceived graph characteristic is improper, the method includes at least one of notifying the user that the perceived graph characteristic is improper or adjusting the health-monitoring graph on the screen so that that the perceived graph characteristic is proper relative to the standard graph characteristic.

9. The method of claim 8, wherein the perceived graph characteristic is at least one of an aspect ratio, a channel width, a channel height, a vertical gain, or a sweep speed.

10. The method of claim 8, wherein displaying the health-monitoring graph to the user includes displaying the health-monitoring graph to the user through an application program that is configured to retrieve data for the health-monitoring graph through a communication network.

11. The method of claim 10, wherein determining the perceived graph characteristic is improper relative to the standard graph characteristic includes obtaining size information through the application program, the size information being at least one of a zoom level of the application program, a viewport size of the application program, or a device pixel ratio.

12. The method of claim 10, wherein determining the perceived graph characteristic is improper relative to the standard graph characteristic is performed by a sub-application invoked by the application program.

13. The method of claim 8, wherein monitoring the perceived graph characteristic includes identifying that a graph-changing event has occurred and, in response to identifying that a graph-changing event has occurred, determining the perceived graph characteristic.

14. The method of claim 8, wherein notifying the user includes at least one of (a) providing audible information to the user through an audio system of the device or system; (b) displaying a non-textural alert to the user on the screen; (c) or displaying a textual alert to the user.

15. The method of claim 8, wherein the physiological data is at least one of cardiotocographic data, electrocardiographic data, electroencephalographic data, electromyographic data, electronystagmographic, or polygraphic data.

16. A non-transitory computer-readable storage medium having computer executable code to:
display a health-monitoring graph on a screen of a computing system, the health-monitoring graph including a waveform that represents physiological data of an individual that is plotted with respect to horizontal and vertical axes;
monitor a perceived graph characteristic of the health-monitoring graph, the perceived graph characteristic being related to at least one of the waveform as displayed on the screen or an area of the health-monitoring graph as displayed on the screen; and
determine the perceived graph characteristic is improper relative to a standard graph characteristic for displaying the physiological data;
wherein, in response to determining that the perceived graph characteristic is improper, the computer executable code is configured to at least one of notify the user that the perceived graph characteristic is improper or adjust the health-monitoring graph on the screen so that that the perceived graph characteristic is proper relative to the standard graph characteristic.

17. The computer-readable storage medium of claim 16, wherein the perceived graph characteristic is at least one of an aspect ratio, a channel width, a channel height, a vertical gain, or a sweep speed.

18. The computer-readable storage medium of claim 16, wherein the displaying operation includes displaying the health-monitoring graph to the user through an application program that is configured to retrieve data for the health-monitoring graph through a communication network.

19. The computer-readable storage medium of claim 16, wherein the monitoring operation includes identifying that a graph-changing event has occurred and, in response to identifying that a graph-changing event has occurred, determining the perceived graph characteristic.

20. The computer-readable storage medium of claim 16, wherein the notifying operation includes at least one of (a) providing audible information to the user through an audio system of the device or system; (b) displaying a non-textural alert to the user on the screen; (c) or displaying a textual alert to the user.
